(19) United States
(12) Patent Application Publication
(10) Pub. No.: US 2018/0001907 A1
(43) Pub. Date: Jan. 4, 2018

(54) TANK CAR JACKET STANDOFF CLIP

(71) Applicant: TrinityRail Maintenance Services, Inc., Dallas, TX (US)

(72) Inventors: Matthew Philip Mozingo, Garland, TX (US); Ronald Porter Lawler, Grapevine, TX (US)

(21) Appl. No.: 15/197,144

(22) Filed: Jun. 29, 2016

(51) Int. Cl. B61D 17/04; B61D 5/06; B61D 17/18; F16B 2/24

(52) U.S. Cl. CPC B61D 17/048; F16B 2/241; B61D 5/06; B61D 17/18

(57) ABSTRACT

According to some embodiments, a tank car comprises a tank shell with reinforcing bars extending longitudinally along a bottom of the tank shell. The tank car also comprises clips coupled to the reinforcing bars. A jacket standoff wraps around at least part of a lateral circumference of the tank shell. Each end of the jacket standoff is coupled to one of the clips. According to some embodiments, a clip for attaching a jacket standoff to a tank car comprises a first portion for coupling to a mounting surface of a tank shell; a middle portion shaped to generally conform to a contour of a side of the mounting surface; and a second portion, opposite the first portion, comprising a recessed portion to accept an end of the jacket standoff and positioned such that the second portion is located proximate to the tank shell but not attached to the tank shell.

### TECHNICAL FIELD

Particular embodiments relate generally to insulated railroad tank cars, and more particularly to clips for attaching jacket standoffs to a tank car.

### BACKGROUND

Railroad tank cars transport liquid commodities, such as oil, ethanol, liquid natural gas, etc. Department of Transportation (DOT), Association of American Railroads (AAR), and Transport Canada (TC) specifications require thermal protection for tank cars that transport particular commodities, such as flammable commodities. For example, a DOT 117 compliant tank car blankets the tank shell with an insulating and thermal protection layer, such as a ceramic fiber blanket, which is covered and protected by an outer steel jacket. Jacket standoffs support and separate the jacket from the tank shell and prevent the jacket from overly compressing the insulating material.

Existing tank cars may be retrofitted to meet the DOT 117 standard. For example, insulating material and a jacket may be applied to the tank of an existing tank car, such as a DOT 111 or CPC-1232 tank car, to bring the existing tank car in compliance with DOT 117 requirements.

### SUMMARY

According to some embodiments, a tank car comprises a tank shell and one or more reinforcing bars coupled to the tank shell and extending longitudinally along a bottom of the tank shell. The tank car also comprises a first clip coupled to one of the one or more reinforcing bars and a second clip coupled to one of the one or more reinforcing bars. A first jacket standoff wraps around at least part of a lateral circumference of the tank shell. The jacket standoff comprises a first end coupled to the first clip and a second end coupled to the second clip. The clips comprise a first portion coupled to one of the one or more reinforcing bars and a second portion, opposite the first portion, comprising a recessed portion to accept an end of the first jacket standoff. The second portion is positioned proximate to the tank shell.

According to particular embodiments, the clips comprise a middle portion shaped to generally conform to a contour of a side of the reinforcing bar between the tank shell and the first portion. A cross-section of the middle portion may comprise an S-shape. The recessed portion may comprise a slot through the second portion. Coupling may include welding the first portion to one of the one or more reinforcing bars and welding the first jacket standoff to the recessed portion of the second portion.

According to particular embodiments, the tank car comprises a top fitting coupled to the tank shell, a third clip coupled to the top fitting, and a fourth clip coupled to one of the one or more reinforcing bars. A second jacket standoff wraps around at least part of a lateral circumference of the tank shell comprising a first end coupled to the third clip and a second end coupled to the fourth clip.

According to particular embodiments, the third clip comprises a first portion coupled to the top fitting; a middle portion shaped to generally conform to a contour of a side of the top fitting between the tank shell and the first portion; and a second portion, opposite the first portion, comprising a recessed portion to accept an end of the second jacket standoff and positioned proximate to the tank shell but not attached to the tank shell.

According to particular embodiments, a gap between the first jacket standoff and the tank shell is less than approximately 1/16″ at any location around a lateral circumference of the tank shell, except for within approximately 6″ of the first or the second clip or within approximately 12″ of a longitudinal seam of the tank shell.

According to some embodiments, a clip for attaching a jacket standoff to a tank car comprises a first portion for coupling to a mounting surface of a tank shell that has been previously stress-relieved; and a second portion, opposite the first portion, comprising a recessed portion to accept an end of the jacket standoff. The second portion is positioned such that the second portion is located proximate to the tank shell when the first portion is coupled to the mounting surface of the tank shell.

According to particular embodiments, the clip further comprises a middle portion shaped to generally conform to a contour of a side of the mounting surface between the tank shell and the first portion when the first portion is coupled to the mounting surface of the tank shell. The mounting surface may comprise a reinforcing bar coupled to the tank shell and the middle portion may be shaped to generally conform to a contour of a side of the reinforcing bar between the tank shell and the first portion when the first portion is coupled to the reinforcing bar. The mounting surface may comprise a top fitting and the middle portion may be shaped to generally conform to a contour of a side of the top fitting between the tank shell and the first portion when the first portion is coupled to the top fitting. A cross-section of the middle portion may comprise an S-shape. The recessed portion may comprise a slot through the second portion.

According to some embodiments, a method of retrofitting a jacket onto a stress-relieved tank shell comprises coupling a first clip to one of one or more reinforcing bars coupled to a tank shell and extending longitudinally along a bottom of the tank shell. The method includes coupling a second clip to one of the one or more reinforcing bars and coupling a first end of a first jacket standoff to the first clip. The first jacket standoff is wrapped around at least a part of a lateral circumference of the tank shell, and a second end of the first jacket standoff is coupled to the second clip.

According to particular embodiments, coupling the first clip to one of the one or more reinforcing bars comprises welding the first clip to one of the one or more reinforcing bars and coupling the first end of the first jacket standoff to the first clip comprises welding the first end of the first jacket standoff to the recessed portion of the second portion of the first clip.

According to particular embodiments, the method optionally comprises coupling a third clip to a top fitting of the tank shell; coupling a fourth clip to one of the one or more reinforcing bars; coupling a first end of a second jacket standoff to the third clip; wrapping the second jacket standoff around at least a part of a lateral circumference of the tank shell; and coupling a second end of the second jacket standoff to the fourth clip. The first jacket standoff may be pre-rolled.

According to particular embodiments, the method optionally comprises pressing the first jacket standoff to the tank shell near the first clip and near the second clip to reduce a gap between the jacket standoff and the tank shell.

Particular embodiments may exhibit some of the following technical advantages. Particular embodiments enable jacket standoffs to be retrofitted to an existing tank car without welding to the tank and incurring the expense of an additional heat treatment. Particular embodiments enable full coverage of a jacket standoff around the circumference of the tank without welding supports directly to the tank. In particular embodiments, the clip is shaped to provide a tight fit between the jacket standoff and the tank shell, which prevents shifting. Other technical advantages will be readily apparent to one skilled in the art from the following figures, description and claims.

### BRIEF DESCRIPTION OF THE DRAWINGS

For a more complete understanding of the embodiments and their features and advantages, reference is now made to the following description, taken in conjunction with the accompanying drawings, in which:

FIG. 1 is a schematic diagram illustrating an example insulated tank car with cutout illustrating the thermal layers;

FIG. 2 is a schematic diagram of a side view of a tank shell with jacket standoffs, according to a particular embodiment;

FIG. 3 is a schematic diagram of a bottom view of a tank shell with jacket standoffs and clips, according to a particular embodiment;

FIG. 4 is a schematic diagram of a cross section view of a tank shell with jacket standoffs and clips coupled to reinforcing bars, according to a particular embodiment;

FIG. 5 is a schematic diagram of an overhead view of a clip and jacket standoff coupled to a reinforcing bar, according to a particular embodiment;

FIG. 6 is a schematic diagram of a side view of a clip and jacket standoff coupled to a top fitting, according to a particular embodiment;

FIG. 7 is a schematic diagram of a perspective view of a clip, according to a particular embodiment; and

FIG. 8 is a flow diagram illustrating an example method of retrofitting a jacket onto a stress-relieved tank shell, according to some embodiments.

### DETAILED DESCRIPTION

Production of new railroad tank cars, such as DOT 117 compliant tank cars, includes welding jacket standoffs directly to the tank shell. After completing all the welding on the tank, the entire tank assembly is stress-relieved. In a retrofit application (i.e., after initial stress-relieving of the tank), any further welding to the tank requires costly and time-consuming post-weld heat treatment operations.

An object of the present disclosure is to obviate at least these disadvantages and provide a clip for attaching a jacket standoff to an existing tank car without welding to the tank. The embodiments described herein include a clip for attaching a jacket standoff to an existing tank car without welding to the tank. The embodiments described herein include a clip that may be welded to locations that do not require post-weld heat treatment, such as the bottom reinforcement bars of the tank or a pad for one of the top fittings. A standoff bar may be formed to wrap around the circumference of the tank and may be welded to the clip. In particular embodiments, the clip holds the jacket standoff bar tight to the tank shell.

The following description sets forth numerous specific details. It is understood, however, that embodiments may be practiced without these specific details. In other instances, well-known structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

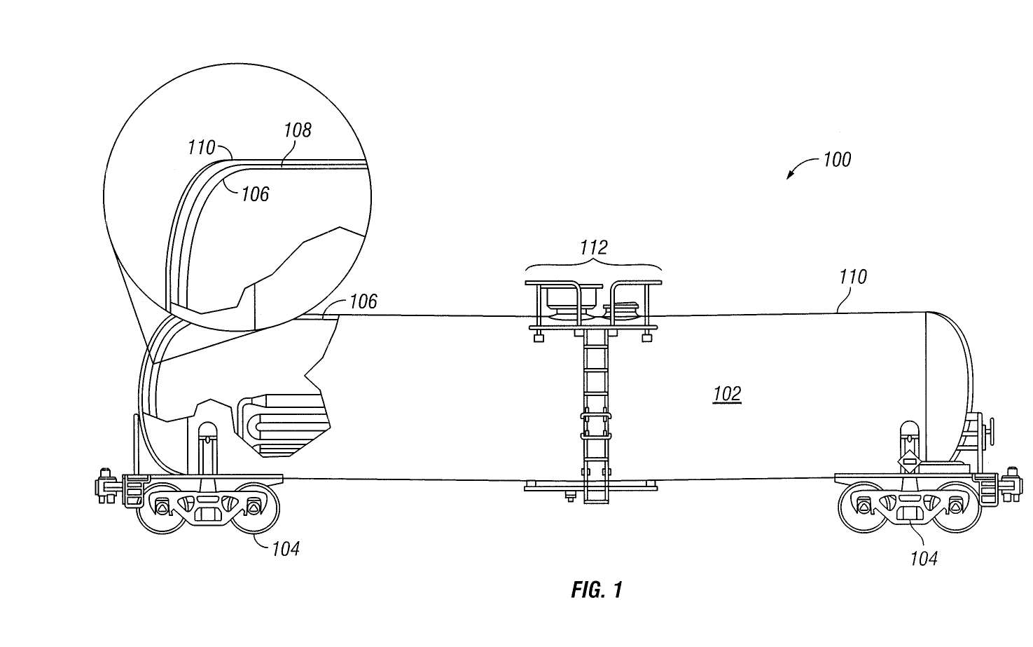

Particular embodiments are described with reference to FIGS. 1-8 of the drawings, like numerals being used for like and corresponding parts of the various drawings. A railroad tank car is used throughout this disclosure as an example, but the ideas presented herein may apply to other tanks as well, such as tanks on other types of railcars, vehicles, or vessels, or any tank being retrofitted with a jacketed thermal layer.

FIG. 1 is a schematic diagram illustrating an example insulated tank car with cutout illustrating the thermal layers. Tank car 100 includes tank 102 coupled to trucks 104. Trucks 104 are connected by a center sill (not illustrated). The center sill also supports tank 102. Tank car 100 also includes top fittings 112. Top fittings 112 include protective nozzles that house various valves, gauges, inlet/outlet connections, manways, and other equipment. Top fittings 112 may be coupled to tank 102 with structural pads.

Tank 102 comprises tank shell 106, insulating material 108, and jacket 110. Tank shell 102 contains the commodity for transport, such as oil or any other liquid. Insulating material 108 blankets tank shell 106 to provide insulation and thermal protection for tank shell 106. Jacket 110 provides a protective, weatherproof cover for tank shell 106 and insulating material 108. The cutout portion of FIG. 1 illustrates the layering of tank shell 106, insulating material 108, and jacket 110. Jacket 110 may comprise steel or any other suitable material for jacketing a tank car.

Jacket standoffs separate the jacket from the tank shell. The jacket standoffs provide support for the jacket and prevent the jacket from overly compressing the insulating material.

New railroad tank cars, such as DOT 117 compliant tank cars, may include jacket standoffs welded directly to the tank shell. After completing all the welding on the tank, the entire tank assembly is stress-relieved. In a retrofit application, however, any further welding to the tank requires costly and time-consuming post-weld heat treatment operations.

Particular embodiments include a clip that may be welded to locations that do not require post-weld heat treatment, such as the bottom reinforcement bars of the tank, a structural pad, or any other suitable surface. A jacket standoff bar may be formed to wrap around the circumference of the tank and may be welded to one or more clips. The thickness of the jacket standoff bar provides support for the jacket. The jacket standoff bar may make contact with, but is not attached to, the tank shell.

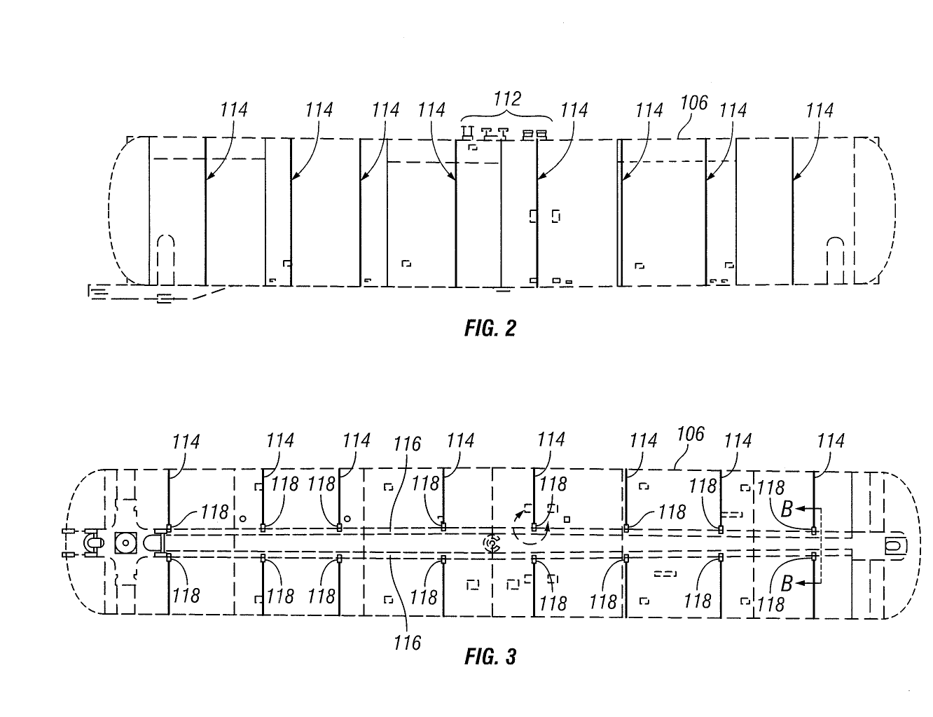

FIG. 2 is a schematic diagram of a side view of a tank shell with jacket standoffs, according to a particular embodiment. Tank shell 106 includes a plurality of jacket standoffs 114.

In particular embodiments, jacket standoffs 114 wrap around a lateral circumference of tank shell 106. In particular embodiments, jacket standoffs 114 comprise ½″ steel round bar. In other embodiments, jacket standoffs 114 may comprise any suitable material of any suitable shape or diameter for a particular combination of tank shell, insulating material, and jacket.

In particular embodiments, plurality of jacket standoffs 114 are spaced longitudinally along tank shell 106 to provide support for a jacket, such as jacket 110 illustrated in FIG. 1. In particular embodiments, the spacing between jacket standoffs 114 may be approximately between 4 and 6 feet. Particular embodiments may vary the spacing between particular jacket standoffs 114 to avoid obstacles, such as a lateral seam or some other protrusion from tank shell 106. Some embodiments may use any spacing between jacket standoffs 114 suitable for a particular combination of tank shell, insulating material, and jacket.

FIG. 3 is a schematic diagram of a bottom view of a tank shell with jacket standoffs and clips, according to a particular embodiment. The bottom of tank shell 106 includes reinforcing bars 116 extending longitudinally along tank shell 106. Particular embodiments include two reinforcing bars 116 located parallel to each other along the bottom of tank shell 106.

Reinforcing bars 116 provide support for tank shell 106. Standards organizations (e.g., DOT, AAR, TC) do not consider reinforcing bars 116 as part of the tank assembly, thus welding to reinforcing bars 116 does not require post-weld heat treatment of tank shell 106.

Coupling jacket standoffs 114 directly to reinforcing bars 116, however, results in a gap between jacket standoff 114 and tank shell 106 at the location where jacket standoff 114 transitions from reinforcing bar 116 to tank shell 106. Too large of a gap may result in movement and possible twisting of jacket standoff 114. To obviate this problem, clip 118 mounts to reinforcing bar 116 and is shaped to provide an attachment point for jacket standoff 114 that positions jacket standoff 114 in close proximity to tank shell 106.

In particular embodiments, reinforcing bars 116 provide an attachment point for clips 118. Clips 118 couple jacket standoffs 114 to reinforcing bar 116. For example, a first clip 118 may be welded to a first reinforcing bar 116 on the bottom of tank shell 106. A first end of jacket standoff 114 may be welded to clip 118. Jacket standoff 114 may wrap around a lateral circumference of tank shell 106 to a second reinforcing bar 116 on the bottom of tank shell 106 parallel to the first reinforcing bar 116. A second clip 118 may be welded to second reinforcing bar 116 and a second end of jacket standoff 114 may be welded to second clip 118.

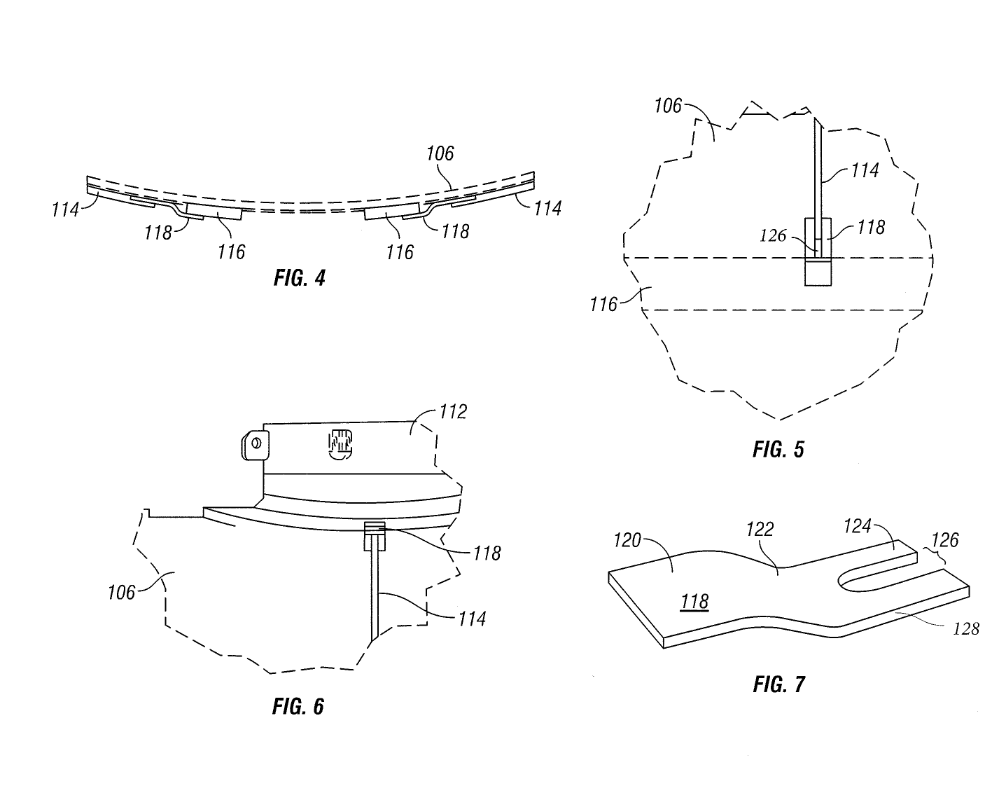

For example, the view arrows labelled B-B in FIG. 3 refer to a close-up view of a pair of clips 118 coupling jacket standoff 114 to a pair of reinforcing bars 116. FIG. 4 illustrates the view represented by the arrows labelled B-B.

FIG. 4 is a schematic diagram of a cross section view of a tank shell with jacket standoffs and clips coupled to reinforcing bars, according to a particular embodiment. Tank shell 106 and reinforcing bars 116 may comprise portions of an existing tank car. Jacket standoff 114 and clips 118 may be used to retrofit insulating material and a jacket to tank shell 106 without performing any welding on tank shell 106.

In the illustrated embodiment, clip 118 is shaped to generally conform to the contour of a side of reinforcing bar 116. The contour of clip 118 reduces space between jacket standoff 114 and tank shell 106 at the coupling location with reinforcing bar 116.

In particular embodiments, clip 118 may include a recessed portion to accept an end of jacket standoff 114 (e.g., recessed portion 126 of clip 118 illustrated in FIG. 7). In particular embodiments, the recessed portion may comprise a slot (i.e., the recess extends entirely through thickness 128 of clip 118 of FIG. 7). The recessed portion of clip 118 may position jacket standoff 114 closer to tank shell 106 by reducing the thickness of clip 118 at the location where jacket standoff 114 couples to clip 118. Even for embodiments where the recessed portion comprises a slot, jacket standoff 114 is coupled (e.g., welded) to clip 118 and is not attached to tank shell 106.

FIG. 5 is a schematic diagram of an overhead view of a clip and jacket standoff coupled to a reinforcing bar, according to a particular embodiment. The view is referred to as an overhead view because it looks down on the components. As viewed on a physical tank car, however, the view is from beneath the tank car looking up towards the underside the tank car, such as the bottom view of tank car 100 illustrated in FIG. 3. Tank shell 106, jacket standoff 114, reinforcing bar 116, and clip 118 are similar to those described with respect to FIGS. 1-4.

In particular embodiments, jacket standoff 114 may be coupled to recessed portion 126 of clip 118. In the illustrated embodiment, jacket standoff 114 does not occupy the entire recessed portion 126 of clip 118 (i.e., clip 118 occupies approximately half the length of recessed portion 126). In particular embodiments, jacket standoff 114 may be trimmed to fit during installation. The mounting area of clip 118 for jacket standoff 114 is sized so that the trimming process does not need to be precise, which may facilitate easier installation. For example, jacket standoff 114 may be trimmed to fill the entire length of recessed portion 126, half the length of recessed portion 126 (as illustrated), less than half the length of recessed portion 126, or any suitable portion sufficient to securely couple jacket standoff 114 to clip 118.

In some embodiments, obstructions on tank shell 106 may prevent jacket standoff 114 from wrapping all the way from one reinforcing bar 116 and around tank shell 106 to parallel reinforcing bar 116. In some embodiments, jacket standoff 114 may be located to avoid obstructions. For larger obstructions, such as top fittings, particular embodiments may include clips 118 that couple to the obstruction, such as a pad that couples the obstruction to tank shell 106. For example, particular embodiments may include clips 118 that mount to a top fitting nozzle. In such embodiments, jacket standoff 114 may wrap around a partial circumference of tank shell 106 between reinforcing bar 116 and top fitting 112. An opposite side of tank shell 106 may include a similar configuration to wrap the partial circumference of the opposite side.

FIG. 6 is a schematic diagram of a side view of a clip and jacket standoff coupled to a top fitting, according to a particular embodiment. Jacket standoff 114 is similar to jacket standoff 114 described with respect to FIGS. 1-5, except in particular embodiments jacket standoff 114 may comprise a different length. For example, instead of wrapping almost entirely around a circumference of tank shell 106 (e.g., from one reinforcing bar to another), in particular embodiments jacket standoff 114 may wrap partially around a circumference of tank shell 106 (e.g., from reinforcing bar to top fitting).

In the illustrated embodiment, clip 118 is shaped to generally conform to the contour of a portion of top fitting 112. The contour of clip 118 reduces space between jacket standoff 114 and tank shell 106 at the coupling location with top fitting 112. In particular embodiments, clip 118 may also include a recessed portion as described with respect to FIGS. 4 and 5.

FIG. 7 is a schematic diagram of a perspective view of a clip, according to a particular embodiment. Clip 118 includes first portion 120, middle portion 122, and second portion 124. First portion 120 is shaped to facilitate coupling to a portion of tank car 100 in close proximity to tank shell 106, but not a portion of the tank assembly that would require post-weld heat treatment. For example, first portion 120 may be shaped to facilitate coupling to reinforcing bar 116, top fitting 112, or any other suitable coupling location. In particular embodiments, coupling may include welding.

Middle portion 122 is shaped to generally conform to a contour between the coupling location of first portion 120 (e.g., reinforcing bar 116, top fitting 112, etc.) and tank shell 106. Middle portion 122 is not welded to tank shell 106. Although middle portion 122 is generally illustrated with a cross-section comprising a step or S-shape, other embodiments may include any suitable cross-sectional shape corresponding to the coupling location of clip 118.

Second portion 124 is shaped to accept jacket standoff 114 and to position jacket standoff 114 proximate to tank shell 106. Second portion 124 is not welded to tank shell 106. Second portion 124 comprises a particular thickness 128. In particular embodiments, thickness 128 may comprise any suitable thickness between approximately ⅛″ and approximately ½″.

In particular embodiments, second portion 124 may include recessed portion 126. In the illustrated embodiment, recessed portion 126 forms a slot through second portion 124 (i.e., a slot through thickness 128). In some embodiments, recessed portion 126 may comprise a depth less than thickness 128, such as a concave depression in second portion 124. Recessed portion 126 is shaped to accept jacket standoff 114 to position jacket standoff 114 closer to tank shell 106.

For example, a jacket standoff 114 welded to the surface of second portion 124 is at least thickness 128 away from tank shell 106. A particular advantage of recessed portion 126 is that jacket standoff 114 may be positioned closer than thickness 128 to tank shell 106.

Particular embodiments enable jacket standoffs 114 to be retrofitted to tank car 100 without welding to tank 102 and incurring the expense of an additional heat treatment. Particular embodiments enable full coverage of jacket standoff 114 around the circumference of tank shell 106 without welding supports directly to tank 102. In particular embodiments, clip 118 provides a tight fit between jacket standoff 114 and tank shell 106, which prevents shifting of jacket standoff 114. In particular embodiments, jacket standoff 114 is generally separated from tank shell 106 by between 0″ and approximately 1/16″, except in particular locations. In particular embodiments, jacket standoff 114 may be more than 1/16″ away from tank shell 106 within approximately 6″ of any clip 118, or within approximately 12″ on either side of a longitudinal seam of tank shell 106.

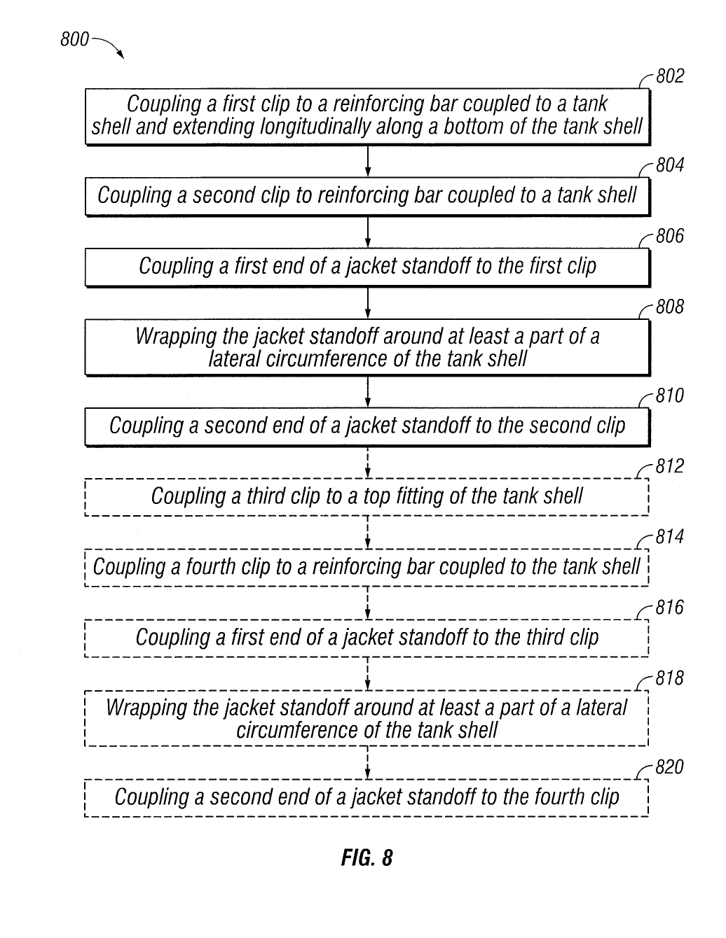

FIG. 8 is a flow diagram illustrating an example method of retrofitting a jacket onto a stress-relieved tank shell, according to some embodiments. In particular embodiments, one or more steps of FIG. 8 may be performed to retrofit a tank car, such as tank car 100 described with respect to FIGS. 1-7.

The method begins at step 802, where a first clip is coupled to a reinforcing bar coupled to a tank shell and extending longitudinally along a bottom of the tank shell. For example, first clip 118 may be coupled to reinforcing bar 116 of tank shell 106. In particular embodiments, coupling may include welding, or any other suitable means of attaching first clip 118 to reinforcing bar 116.

At step 804, a second clip is coupled to a reinforcing bar. For example, second clip 118 may be coupled to reinforcing bar 116 that runs parallel to reinforcing bar 116 described in step 802. In other embodiments, particular tanks may include a single reinforcing bar or no reinforcing bars. In these embodiments, second clip 118 may be coupled to an opposite side of reinforcing bar 116 described in step 802, or second clip 118 may be coupled to any other suitable component attached to the tank that does not require post-weld heat-treatment.

At step 806, a first end of a jacket standoff is coupled to the first clip. For example, a first end of jacket standoff 114 may be coupled to first clip 118. In particular embodiments, coupling may include welding, or any other suitable means of attaching jacket standoff 114 to first clip 118.

In particular embodiments, jacket standoff 114 may be pressed (e.g., by hydraulic press, spring, hammer, etc.) to tank shell 106 near first clip 118. Pressing jacket standoff 114 may reduce a gap between jacket standoff 114 and tank shell 106.

At step 808, the jacket standoff is wrapped around at least a part of a lateral circumference of the tank shell. For example, jacket standoff 114 may be wrapped around a lateral circumference of tank shell 106 to second clip 118 coupled to reinforcing bar 116.

In particular embodiments, jacket standoff 114 may be pre-rolled to facilitate easier wrapping around tank shell 106. Jacket standoff 114 may be wrapped by hand, wrapped using a bending machine suitable for the particular size and material of jacket standoff 114, or wrapped using any combination of methods.

At step 810, a second end of the jacket standoff is coupled to the second clip. For example, a second end of jacket standoff 114 may be coupled to second clip 118.

In particular embodiments, coupling may include welding, or any other suitable means of attaching jacket standoff 114 to second clip 118. In particular embodiments, jacket standoff 114 may be pre-cut to an approximate length. In particular embodiments, jacket standoff may be trimmed to length after wrapping around tank shell 106 and before coupling to second clip 118.

In particular embodiments, jacket standoff 114 may be pressed (e.g., by hydraulic press, spring, hammer, etc.) to tank shell 106 near second clip 118. Pressing jacket standoff 114 may reduce a gap between jacket standoff 114 and tank shell 106. In some embodiments, jacket standoff 114 may be pressed to tank shell 106 at other locations, such as near a longitudinal seam in tank shell 106.

Steps 802 to 810 may be repeated any suitable number of times to couple any suitable number of jacket standoffs to the tank shell. Some embodiments may couple jacket standoffs to other components, such as top fittings.

At optional step 812, a third clip is coupled to a top fitting of the tank shell. For example, third clip 118 is coupled to top fitting 112 of tank shell 106. While first and second clips 118 described above may generally conform to a contour of a side of a reinforcing bar, third clip 118 may generally conform to a contour of a side of the top fitting.

At optional step 814, a fourth clip is coupled to a reinforcing bar. For example, fourth clip 118 may be coupled to reinforcing bar 116.

At optional step 816, a first end of jacket standoff is coupled to the third clip. For example, a first end of jacket standoff 114 may be coupled to third clip 118.

At optional step 818, the jacket standoff is wrapped around part of a lateral circumference of the tank shell. For example, jacket standoff 114 may be wrapped around the part of the lateral circumference of tank shell 106 between top fitting 112 and reinforcing bar 116. In particular embodiments, jacket standoff 114 may be pre-rolled, may comprise a predetermined length, and/or may be trimmed to an appropriate length after wrapping. Particular embodiments may include pressing of jacket standoff 144 near clips 118, or at any other suitable location, such as a longitudinal seam of tank shell 106.

At optional step 820, a second end of the jacket standoff is coupled to the fourth clip. For example, a second end of jacket standoff 114 may be coupled to fourth clip 118.

Steps 812 to 820 may be repeated any suitable number of times to couple any suitable number of jacket standoffs to the tank shell. Modifications, additions, or omissions may be made to method 800. Additionally, one or more steps in method 800 of FIG. 8 may be performed in parallel or in any suitable order. For example, clips and jacket standoffs may be installed from the center of the tank outwards, or from one end to another. In particular embodiments, more than one jacket standoff and/or clip may be installed in parallel. In particular embodiments, only one of two clips may be installed before their corresponding jacket standoff is wrapped, or both clips may be installed before their corresponding jacket standoff is wrapped. In some embodiments, all clips may be installed before any jacket standoffs are installed. In some embodiments, all clips on one side of the tank car may be installed before any jacket standoffs are installed.

Some embodiments of the disclosure may provide one or more technical advantages. As an example, particular embodiments enable jacket standoffs to be retrofitted to an existing tank car without welding to the tank and incurring the expense of an additional heat treatment. Particular embodiments enable full coverage of a jacket standoff around the circumference of the tank without welding supports directly to the tank. In particular embodiments, the clip is shaped to provide a tight fit between the jacket standoff and the tank shell, which prevents shifting. Some embodiments may benefit from some, none, or all of these advantages. Other technical advantages may be readily ascertained by one of ordinary skill in the art.

Modifications, additions, or omissions may be made to the systems and apparatuses disclosed herein without departing from the scope of the invention. The components of the systems and apparatuses may be integrated or separated.

Modifications, additions, or omissions may be made to the methods disclosed herein without departing from the scope of the invention. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the claims below.

1. A tank car comprising:
a tank shell;
one or more reinforcing bars coupled to the tank shell and extending longitudinally along a bottom of the tank shell;
a first clip coupled to one of the one or more reinforcing bars and a second clip coupled to one of the one or more reinforcing bars;
a first jacket standoff wrapping around at least part of a lateral circumference of the tank shell comprising a first end coupled to the first clip and a second end coupled to the second clip; and
wherein at least one of the first clip and the second clip comprises:
a first portion coupled to one of the one or more reinforcing bars; and
a second portion, opposite the first portion, the second portion comprising a recessed portion to accept an end of the first jacket standoff, the second portion positioned proximate to the tank shell.

2. The tank car of claim 1, wherein the at least one of the first clip and the second clip further comprises a middle portion shaped to generally conform to a contour of a side of the reinforcing bar between the tank shell and the first portion.

3. The tank car of claim 2, wherein a cross-section of the middle portion of the at least one of the first clip and the second clip comprises an S-shape.

4. The tank car of claim 1, wherein the recessed portion of at least one of the first clip and the second clip comprises a slot through the second portion.

5. The tank car of claim 1, wherein the first portion is welded to one of the one or more reinforcing bars and the first jacket standoff is welded to the recessed portion of the second portion.

6. The tank car of claim 1, further comprising:
a top fitting coupled to the tank shell;
a third clip coupled to the top fitting and a fourth clip coupled to one of the one or more reinforcing bars; and
a second jacket standoff wrapping around at least part of a lateral circumference of the tank shell comprising a first end coupled to the third clip and a second end coupled to the fourth clip.

7. The tank car of claim 6, wherein the third clip comprises:
a first portion coupled to the top fitting;
a middle portion shaped to generally conform to a contour of a side of the top fitting between the tank shell and the first portion; and
a second portion, opposite the first portion, the second portion comprising a recessed portion to accept an end of the second jacket standoff, the second portion positioned proximate to the tank shell.

8. A clip for attaching a jacket standoff to a tank car, the clip comprising:
a first portion for coupling to a mounting surface of a tank shell that has been previously stress-relieved; and
a second portion, opposite the first portion, the second portion comprising a recessed portion to accept an end of the jacket standoff, the second portion positioned such that the second portion is located proximate to the tank shell when the first portion is coupled to the mounting surface of the tank shell.

9. The clip of claim 8, further comprising a middle portion shaped to generally conform to a contour of a side of the mounting surface between the tank shell and the first portion when the first portion is coupled to the mounting surface of the tank shell.

10. The clip of claim 9, wherein the mounting surface comprises a reinforcing bar coupled to the tank shell and extending longitudinally along a bottom of the tank shell and the middle portion is shaped to generally conform to a contour of a side of the reinforcing bar between the tank shell and the first portion when the first portion is coupled to the reinforcing bar.

11. The clip of claim 9, wherein the mounting surface comprises a top fitting and the middle portion is shaped to generally conform to a contour of a side of the top fitting between the tank shell and the first portion when the first portion is coupled to the top fitting.

12. The clip of claim 9, wherein a cross-section of the middle portion comprises an S-shape.

13. The clip of claim 8, wherein the recessed portion comprises a slot through the second portion.

14. A method of retrofitting a jacket onto a stress-relieved tank shell, the tank shell including one or more reinforcing bars coupled to the tank shell and extending longitudinally along a bottom of the tank shell, the method comprising:
providing a first jacket standoff;
providing a first clip and a second clip, at least one of the first clip and the second clip comprising:
a first portion for coupling to the one or more reinforcing bars of the tank shell; and
a second portion, opposite the first portion, the second portion comprising a recessed portion to accept an end of the first jacket standoff, the second portion configured to position the jacket standoff proximate to the tank shell;
coupling the first clip to one of the one or more reinforcing bars;
coupling the second clip to one of the one or more reinforcing bars;
coupling a first end of the first jacket standoff to the first clip;
wrapping the first jacket standoff around at least a part of a lateral circumference of the tank shell; and
coupling a second end of the first jacket standoff to the second clip.

15. The method of claim 14, wherein the at least one of the first clip and the second clip further comprises a middle portion shaped to generally conform to a contour of a side of the reinforcing bar between the tank shell and the first portion.

16. The method of claim 15, wherein a cross-section of the middle portion of the at least one of the first clip and the second clip comprises an S-shape.

17. The method of claim 14, wherein the recessed portion of the at least one of the first clip and the second clip comprises a slot through the second portion.

18. The method of claim 14, wherein the first jacket standoff is pre-rolled.

19. The method of claim 14, further comprising pressing the first jacket standoff to the tank shell near the first clip and near the second clip to reduce a gap between the jacket standoff and the tank shell.

20. The method of claim 14, further comprising:
coupling a third clip to a top fitting of the tank shell;
coupling a fourth clip to one of the one or more reinforcing bars;
coupling a first end of a second jacket standoff to the third clip;
wrapping the second jacket standoff around at least a part of a lateral circumference of the tank shell;
coupling a second end of the second jacket standoff to the fourth clip; and
wherein the third clip comprises:
a first portion coupled to the top fitting;
a middle portion shaped to generally conform to a contour of a side of the top fitting between the tank shell and the first portion; and
a second portion, opposite the first portion, the second portion comprising a recessed portion to accept an end of the second jacket standoff, the second portion positioned proximate to the tank shell but not attached to the tank shell.
